(19) United States
(12) Patent Application Publication
(10) Pub. No.: US 2013/0309369 A1
(43) Pub. Date: Nov. 21, 2013

(54) REINFORCED EDIBLE IMAGE-SUBSTRATE FOR DECORATING FOODSTUFFS

(71) Applicant: Amanda Hershberg, Sitka, AK (US)

(72) Inventor: Amanda Hershberg, Sitka, AK (US)

(21) Appl. No.: 13/477,023

(22) Filed: May 21, 2012

(51) Int. Cl. A23P 1/10; A23C 9/18; A23L 1/22; A23L 1/10; A23L 1/08; A23L 1/212; A23L 1/09; A23G 3/34; A23L 1/48; A23L 1/27

(52) U.S. Cl. 426/103; 426/104; 426/89; 426/383

(57) ABSTRACT

A reinforced edible image-substrate for decorating foodstuffs capable of having high-resolution images printed thereon and also capable of retaining multi-dimensional shapes is disclosed herein. In one embodiment, the reinforced edible image-substrate includes an edible paper base layer having a top surface and a bottom surface and an edible image-substrate coating disposed on at least one of the top surface and the bottom surface of the edible paper base layer. It is an object of the reinforced edible image-substrate disclosed herein to be capable of accepting high-resolution images, to be sufficiently stiff to retain multi-dimensional shapes without collapsing, and also to be sufficiently flexible to be capable of being bent, folded, and/or creased while maintaining sufficient integrity to retain desired multi-dimensional shapes. The reinforced edible image-substrate disclosed herein solves the long felt need of decorating foodstuffs with intricate and lasting multi-dimensional edible shapes with high-resolution images printed thereon.

### FIELD OF THE INVENTION

A reinforced edible image-substrate for decorating foodstuffs is disclosed herein.

### BACKGROUND

A market currently exists for edible image-substrates, which are edible substrates capable of having an edible image printed thereon. Generally, an edible image-substrate is produced and distributed on a carrier release media and is subsequently decorated, typically by running the carrier release media and edible image-substrate together through a standard ink jet printer configured to print with edible inks Finally, the edible image-substrate is peeled from the carrier release media just prior to being applied to the surface of a food product. It is very common for this type of edible substrate to be used in decorating “iced” or “frosted” cakes, cookies, cupcakes, or any other similar product.

U.S. Pat. No. 6,616,958 and U.S. Pat. No. 6,652,897, both to Stewart and both fully incorporated by reference herein, dated Sep. 9, 2003, and Nov. 15, 2003, respectively, disclose an edible image-substrate film and a method of using the same for decorating foodstuffs. The edible image-substrate film according to the Stewart patents comprise an edible polymer film which is releasably mounted upon a flexible substrate that provides reinforcement to the edible image-substrate film. The reinforcement provides the edible image-substrate film with sufficient support to be run through and printed thereon by a standard ink jet printer. The edible image-substrate film is then peelably released from the flexible substrate to provide decorations for the foodstuffs. However, the edible image-substrate film is very thin and yielding which makes its handling difficult once removed from the flexible substrate. Moreover, the edible film cannot be formed into a multi-dimensional shape and then immediately used as a decoration in the desired shape. As used herein, multi-dimensional means any shape in which any portion of the material does not collapse onto the underlying support, e.g., cantilevered portions of a material or vertically standing portions of a material. In some instances, the edible film is formed into multi-dimensional shapes by shaping and temporarily supporting the edible film, allowing the edible film to completely dry and harden, and lastly removing the temporary support. However, this process of creating multi-dimensional shapes is extremely labor and time consuming, and the final product is both brittle and fragile. There has been no suggestion of creating a reinforced edible image-substrate which is capable of accepting high resolution images, such as through being printed on using a standard ink jet printer, and then quickly folded into or simply stood up as a multi-dimensional shape and then immediately used for decorating a foodstuff. Therefore, a reinforced edible image-substrate which is easy to handle, structurally superior to the edible film disclosed in the Stewart patents, and capable of accepting a high-resolution image and immediately thereafter being used to decorate a foodstuff as a multi-dimensional shape is desirable.

U.S. Pat. No. 6,893,671 to Ben-Yoseph et al, dated May 17, 2005, and fully incorporated by reference herein, discloses a chocolate confectionary having on a surface thereof a chocolate base layer, a non-delaminating integral edible image-substrate coating and a method for preparing the same. The confectionary according to the Ben-Yoseph patent is capable of being stood up vertically on a foodstuff as a means of decorating because the chocolate base layer is stiff. However, the chocolate base layer is brittle and inflexible and, therefore, incapable of being fed through standard ink jet printers. Moreover, while the chocolate base layer is disclosed as being able to take any shape or form, including planar and non-planar surfaces, the confectionary is incapable of being folded or otherwise reshaped by the user after the chocolate has hardened in a mold. Additionally, the chocolate base layer is highly prone to melting and is therefore unsuitable for applications in warm environments, especially where the chocolate confectionary might be exposed to direct sunlight. Therefore, a reinforced edible image-substrate which does not use a chocolate base layer, is capable of being fed through most standard ink jet printers, is capable of being folded or otherwise reshaped by the user, and capable of being used in a wide range of environments is desirable.

U.S. Pat. No. 5,017,394 to Macpherson et al, dated May 21, 1991, and fully incorporated by reference herein, discloses a method for making edible base shapes having pictorial images thereon for decorating foodstuffs wherein an edible base shape is screen cast upon a carrier medium and thereafter printed upon preferably by a screen printing process. The base shape is then removed from the carrier medium prior to the base shape being applied to a foodstuff. The edible base shapes produced according to the Macpherson method are highly yielding due to being very thin, e.g., the edible base shapes disclosed by the Macpherson patent are even more yielding than the edible film disclosed in the Stewart patents. The intended and efficient use of the edible base shape is to lay flat on a surface wherein the underlying structure, such as the flat surface of a cookie, directly supports each portion of the edible base shape. In other words, this product is ill suited for forming multi-dimensional shapes within the meaning defined herein. Additionally, in order for a screen casting apparatus to be economically feasible, a large market for a single shape must exist because a single screen cast die will requires a significant initial investment to later be recovered. Therefore, while a method of making edible base shapes using a screen cast may be desirable for shapes which have high demand and for applications where multi-dimensional shapes are not desired, a composition in which it is economically feasible to quickly and accurately make a wide variety of base shapes with a low initial investment and subsequently form multi-dimensional shapes for immediate use as a decoration is also desirable.

U.S. Pat. No. 4,024,287 to Golchert, dated May 17, 1977, and fully incorporated by reference herein, discloses a method of decorating a foodstuff comprising the steps of depositing an edible image onto a transfer medium using edible ink, placing the transfer medium on the food item to be decorated with the color side down, and placing a damp pad on the exposed back face of the transfer medium, thereby causing the edible image to be transferred to the food item. See also U.S. Pat. No. 683,765 to Howard, dated Oct. 1, 1901, and fully incorporated by reference herein, which discloses a method of transferring an image or label from a transfer medium to a meat product. The methods disclosed by the Golchert and Howard patents, and similar methods, are currently used to transfer images to the surfaces of foodstuffs, such as the top of an iced cake, using a transfer paper on which an image is first printed then subsequently transferred to the foodstuff. The transfer paper is typically either wafer paper or rice paper, although, any edible or food grade paper may suffice. Wafer paper is commonly used for this purpose and accordingly typically comes in eight by eleven inch sheets and can be used with most standard ink jet printers. An initial step of this method is to print the desired image onto the transfer paper and allow the ink to completely dry. A subsequent step is to place the transfer paper image side down onto the surface which the image is intended to be transferred. After a predetermined amount of time the transfer paper is removed and image remains on the surface of the foodstuff. This method is overly time and labor intensive. Moreover, the transfer paper is absorbent and, therefore, requires the printer to be put on a low image quality setting to reduce the amount of edible ink deposited in order to prevent the transfer paper from becoming too moist and losing its structural integrity. Because the transfer paper itself is unable to accept high-resolution images, such as the edible film disclosed in U.S. Pat. No. 6,652,897 and U.S. Pat. No. 6,616,958 to Stewart, and image quality is further diminished when the image is transferred to a foodstuff, the resulting image quality is poorer than desired. Finally, transfer paper is dry, brittle, and easily cracks when bent out of its planar shape; as a result, it is unable to be folded into multi-dimensional shapes. Therefore, a reinforced edible image-substrate which is capable of accepting a high resolution image, being folded into a multi-dimensional shape, and then deposited onto a foodstuff for use as a decoration with little time and effort is desirable.

Each of the various attempts at improving the available methods and products of decorating foodstuffs suffer from any or all of: reliance on and limitation by artisan skill and labor, overly complicated processes, overly time consuming processes, poor image resolution or quality, difficult handling prior to application to a foodstuff; thermal instability; and being incapable of producing multi-dimensional shapes with high resolution images printed thereon.

Accordingly, this application discloses a reinforced edible image-substrate for decorating foodstuffs. The reinforced edible image-substrate disclosed can be successfully used by even the very novice artisan, represents a simplification over current practices, consumes less time than existing practices, and allows for multi-dimensional shapes with high resolution images printed thereon to be produced and applied to foodstuffs.

### SUMMARY

A reinforced edible image-substrate for decorating foodstuffs is disclosed herein. In one embodiment, the reinforced edible image-substrate includes an edible paper base layer having a top surface and a bottom surface and an edible image-substrate coating disposed on at least one of the top surface of the edible paper base layer and the bottom surface of the edible paper base layer. In a different embodiment, the reinforced edible image-substrate includes an edible adhesive substance disposed between an edible paper base layer and an edible image-substrate coating, such that the edible adhesive substance prevents delamination of the edible paper base layer from the edible image-substrate coating. It is an object of the reinforced edible image-substrate disclosed herein to be capable of accepting high-resolution edible images, to be sufficiently flexible to be capable of being bent, folded, and/or creased into multi-dimensional shapes as desired by the user without cracking or tearing, and also to be sufficiently stiff to retain the multi-dimensional shapes without collapsing. The reinforced edible image-substrate disclosed herein solves the long felt need of creating intricate and lasting multi-dimensional edible shapes with high-resolution images printed thereon.

### BRIEF DESCRIPTION OF THE DRAWINGS

Embodiments of the present disclosure are described in detail below with reference to the following drawings.

FIG. 1 is a plan view of a full or partially full sheet of a reinforced edible image-substrate comprising an edible image-substrate coating 1 which has not been printed or drawn on.

FIG. 2 is a cross-section of the reinforced edible image-substrate shown in FIG. 1 illustrating the edible image-substrate coating 1 disposed on the top surface of an edible paper base layer 2.

FIG. 3 is a plan view of a full or partially full sheet of a reinforced edible image-substrate comprising an edible image-substrate coating 1 which has not been printed or drawn on.

FIG. 4 is a cross-section of the reinforced edible image-substrate shown in FIG. 3 illustrating an edible adhesive substance 3 disposed between the edible image-substrate coating 1 and an edible paper base layer 2.

FIG. 5 is a plan view of a full or partially full sheet of a reinforced edible image-substrate comprising an edible image-substrate coating 1 which has had one or more images 4 printed or drawn on it.

FIG. 6 is a cross-section of the reinforced edible image-substrate shown in FIG. 5 illustrating the edible image-substrate coating 1 disposed on the top surface of an edible paper base layer 2, and with one or more images 4 printed or drawn on the edible image-substrate coating 1.

FIG. 7 is a plan view of a full or partially full sheet of a reinforced edible image-substrate comprising an edible image-substrate coating 1 which has had one or more images 4 printed or drawn on it.

FIG. 8 is a cross-section of the reinforced edible image-substrate shown in FIG. 5 illustrating the edible image-substrate coating 1, with one or more images 4 printed or drawn on it, disposed on both the top surface and the bottom surface of an edible paper base layer 2.

FIGS. 9-11 are illustrations of preferred applications for the reinforced edible image-substrate disclosed herein.

### DETAILED DESCRIPTION

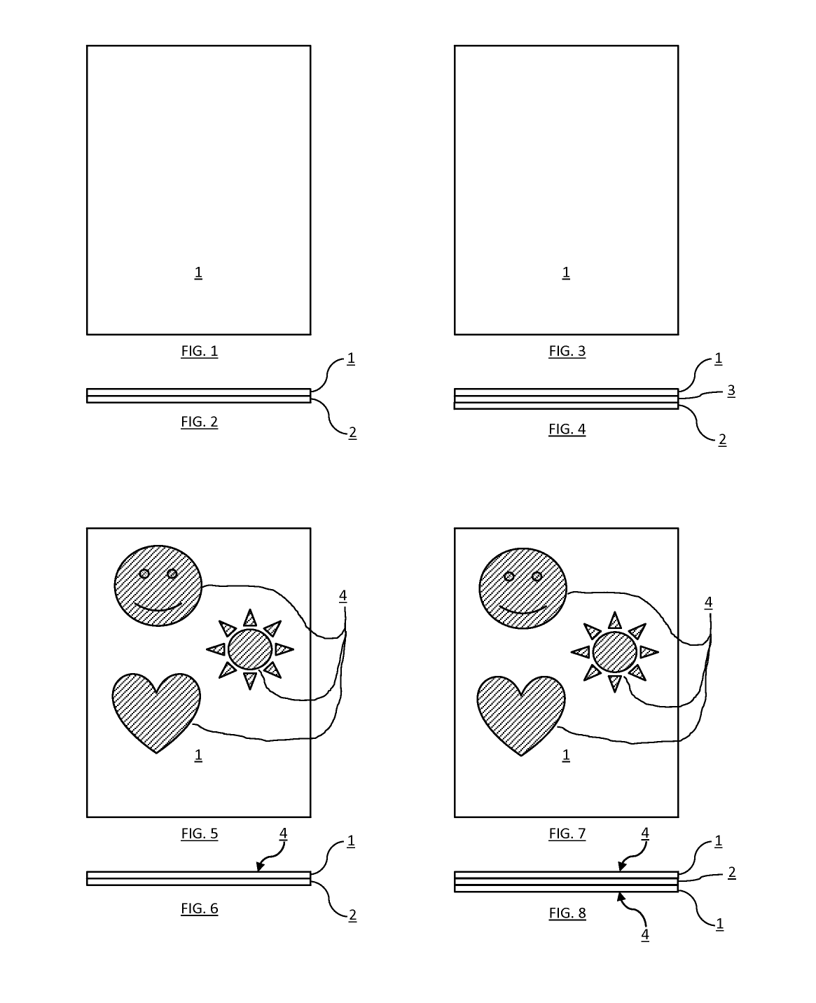

A reinforced edible image-substrate for decorating foodstuffs is disclosed herein. Specific details of certain embodiments of the reinforced edible image-substrate are set forth in the following description and in FIGS. 1-11 to provide a thorough understanding of such embodiments. The present reinforced edible image-substrate may have additional embodiments, may be practiced without one or more of the details described for any particular described embodiment, or may have any detail described for one particular embodiment practiced with any other detail described for another embodiment.

FIG. 1 is a plan view of a full or partially full sheet of a reinforced edible image-substrate comprising an edible image-substrate coating 1. As used herein, edible image-substrate coating 1 means any edible underlying support on which an image may be disposed thereon, and it may be made of any edible substance that is capable of having an image printed, drawn, or otherwise disposed thereon. FIG. 2 is a cross-section of the reinforced edible image-substrate shown in FIG. 1 illustrating the edible image-substrate coating 1 disposed on the top surface of an edible paper base layer 2. The edible image-substrate coating 1 may be disposed on the edible paper base layer 2 by either a manual process or an automated process.

In certain embodiments, the edible image-substrate coating 1 comprises an edible film. As used herein, edible film means any thin layer of edible material. A thickness range between 0.001 and 0.002 inch is preferred for providing a light weight and flexible end product. However, other film thicknesses can be used. Such an edible film may be protein-based, starch-based, wax-based, lipid-based, polysaccharide-based, sugar-based, or may be made of any combination thereof. Generally, a substantially white or light color is preferable for the edible image-substrate coating 1 to optimize the aesthetic appeal of any images printed or drawn thereon. A food grade white pigment, such as titanium dioxide or calcium carbonate, may or may not be used to optimize the color of the edible image-substrate coating 1. Other kinds of edible films known in the art may also be used.

In certain embodiments, the edible image-substrate coating 1 comprises an edible sheet-like layer of icing, e.g., an edible frosting sheet. Generally, the icing layer comprises at least one of: water, starch, cornstarch, corn syrup, corn syrup solids, rice starch, wheat starch, sugar, sucrose, dextrose, fructose, aspartame, binding agent, cellulose, gum Arabic, food grade white pigment, calcium carbonate, titanium dioxide, sorbitol, glycerin, preservative, salt, vegetable oil, polysorbate 80, vanilla, citric acid, or any combination thereof. The edible image-substrate coating 1 preferably has the properties of standard frosting sheet material currently commercially available. For example, suitable edible image-substrate coatings can be obtained from Lucks Food Decorating Company (www.lucks.com), Kopykake Enterprises (www.kopykake.com), Jack Guttman Inc. Bakery Crafts ® (www.bakerycrafts.com), DecoPac Inc. (www.deco-pac.com), and Gilro Ltd. (www.gilro.co.il). Additionally, a number of U.S. patents describe edible substrates suitable for use as the edible image-substrate coating 1 as well as methods of printing images thereon (e.g. U.S. Pat. No. 6,616,958, U.S. Pat. No. 6,652,897, U.S. Pat. No. 6,893,671, U.S. Pat. No. 7,128,938, U.S. Pat. No. 6,582,742, U.S. Pat. No. 6,319,530, and U.S. Pat. No. 6,030,134). These embodiments and descriptions are for illustrative purposes only and are not intended to limit the scope of the reinforced edible image-substrate for decorating foodstuffs. Edible image-substrate coatings useful in the reinforced edible image-substrate for decorating foodstuffs may be of the preprinted or print-on-demand type. Additionally, in some embodiments the edible image-substrate coating 1 is enhanced by the inclusion of at least one of flavoring, colorant, fragrance, or any combination thereof.

In certain embodiments, the edible paper base layer 2 comprises a starch based edible paper, e.g., a transfer paper. The term transfer paper is commonly used in the art to denote any type of paper that may be used to transfer an image onto a surface of a foodstuff. Generally, the transfer paper is a wafer paper or a rice paper. For example, suitable edible paper base layers can be obtained from Lucks Food Decorating Company (www.lucks.com), Kopykake Enterprises (www.kopykake.com), Jack Guttman Inc. Bakery Crafts ® (www.bakerycrafts.com), DecoPac Inc. (www.deco-pac.com), and Gilro Ltd. (www.gilro.co.il). Additionally, a number of U.S. patents describe transfer paper suitable for use as the edible paper base layer 2 and/or methods of printing images on a transfer paper and transferring images therefrom (e.g. U.S. Pat. No. 4,024,287, U.S. Pat. No. 683,765, and U.S. Pat. No. 2,435,047). These embodiments and descriptions are for illustrative purposes only and are not intended to limit the scope of the reinforced edible image-substrate for decorating foodstuffs. Generally, the edible paper base layer 2 is dry, brittle, and easily cracks when bent out of its planar shape. Therefore, the edible paper base layer 2 is unable to be bent, folded, and/or creased into multi-dimensional shapes. Moreover, the edible image-substrate coating 1 is also incapable of being formed into lasting multi-dimensional shapes, such as a decorative bow for placing on top of a cake, without drying the coating as described in the background section herein. However, depositing the edible image-substrate coating 1 onto the edible paper base layer 2 provides an amount of moisture to the edible paper base layer that enables it to be folded and even creased without ripping or tearing while also remaining sufficiently stiff to support the reinforced edible image-substrate in desired multi-dimensional shapes. Preferably, the edible paper base layer 2 comprises a type of transfer paper currently known in the art, e.g., wafer paper or rice paper. However, other kinds of edible paper known in the art may be used. Additionally, in some embodiments the edible paper base layer 2 is enhanced by the inclusion of at least one of flavoring, colorant, fragrance, or any combination thereof.

In some embodiments, the edible image-substrate coating 1 is applied to the edible paper base layer 2 by spraying, rolling, or otherwise depositing the image-substrate coating while it is in a unsolidified state. The edible image-substrate coating may be maintained in an unsolidified state by maintaining the temperature within a predetermined range. Alternatively, an evaporable food grade solvent may be added to the edible image-substrate coating 1 prior to depositing it onto the edible paper base layer 2. Subsequent to depositing the unsolidified edible image-substrate coating, the food grade solvent is allowed to evaporate leaving a non-liquid, smooth, and flexible edible image-substrate coating 1 remaining Preferably the evaporable food grade solvent comprises water, ethanol alcohol, isopropyl alcohol, or any combination thereof. If desired, the composition may be placed in an artificial and/or controlled environment in order to accelerate the evaporation of the food grade solvent. Additionally, other methods of depositing the edible image-substrate coating may be used.

In different embodiments, the edible image-substrate coating 1 is pre-manufactured or pre-purchased prior to being deposited onto the edible paper base layer 2. In these embodiments, the edible paper base layer 2 is typically placed on a hard planar surface and the edible image-substrate coating 1 placed on top thereof Pressure is then applied, preferably uniformly, creating a bond between the edible paper base layer and the edible image-substrate coating. It has been discovered that a silicon rolling pin is useful in accomplishing the desired uniform pressure. The method of applying a pre-manufactured or pre-purchased edible image-substrate coating 2 onto the edible paper base layer 2 is preferred because the edible paper base layer 2 is prone to losing its structural integrity, e.g. by becoming over saturated with moisture and curling up, when it is allowed to absorb too much moisture as is likely to occur when the edible image-substrate coating 1 is applied in a unsolidified state to the edible paper base layer 2.

FIG. 3 is a plan view of a full or partially full sheet of a reinforced edible image-substrate comprising an edible image-substrate coating 1 which has not been printed or drawn on. FIG. 4 is a cross-section of the reinforced edible image-substrate shown in FIG. 3 illustrating an edible adhesive substance 3 disposed between the edible image-substrate coating 1 and an edible paper base layer 2. As used herein, edible adhesive substance means any substance capable of creating a bond between two or more layers of material and generally recognized as safe (GRAS) by the American Food and Drug Administration (FDA) to be added to foods. The edible adhesive substance 3 may be disposed on the edible paper base layer 2 and/or the edible image-substrate coating 1 by either a manual process or an automated process. Additionally, in some embodiments the edible adhesive substance 3 is enhanced by the inclusion of at least one of flavoring, colorant, fragrance, or any combination thereof. Generally, it is a preferred embodiment that an edible adhesive substance 3 is used because it's inclusion in the reinforced edible image-substrate prevents delamination of the edible image-substrate coating 1 from the edible paper base layer 2.

In certain embodiments, the edible adhesive substance 3 comprises a tacky and low moisture foodstuff. For example, in some embodiments the edible adhesive substance comprises at least one of: honey, molasses, sugar syrup, starch gum, corn syrup, high fructose corn syrup, glucose, agave nectar, piping gel, shellac, or any combination thereof. Other tacky and low moisture foodstuffs known in the art may also be used.

In certain embodiments, the edible adhesive substance 3 comprises composition specifically marketed as or designed to be an edible and/or GRAS adhesive. Generally, the edible adhesive layer comprises at least one of: water, tapioca dextrin, dextrose, citric acid, xanthan gum, propylene glycol, sugar, modified food starch (corn), corn syrup, high fructose corn syrup, or any combination thereof. It is generally preferable that the edible adhesive layer further comprise a preservative, e.g., sodium benzoate and/or potassium sorbate. Suitable edible adhesive substances can be obtained from commercially. For example, suitable edible adhesive substances can be obtained from Country Kitchen Sweetart (www.countrykitchensa.com), Wilton (www.wilton.com), and Get Sassie! (getsassie.com). Additionally, a number of U.S. patents describe edible adhesives suitable for use as the edible adhesive substance 3 (e.g. U.S. Pat. No. 6,613,378, and U.S. Pat. No. 5,827,553). These embodiments and descriptions are for illustrative purposes only and are not intended to limit the scope of the reinforced edible image-substrate for decorating foodstuffs. It has been found that corn syrup is a preferred edible adhesive substance 3 because it adds an ideal amount of moisture to the edible paper base layer 2 which makes the reinforced edible image-substrate highly pliable yet durable and resistant to cracking It should be appreciated that while only certain edible adhesives have been disclosed herein, any edible adhesive is intended to be within the scope of the reinforced edible image-substrate disclosed.

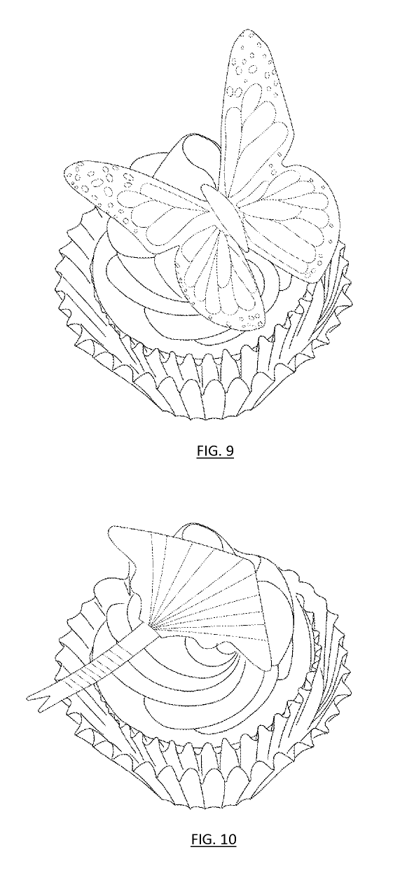

FIG. 5 is a plan view of a full or partially full sheet of a reinforced edible image-substrate comprising an edible image-substrate coating 1 which has had one or more images 4 printed or drawn on it. The images 4 formed on the edible image-substrate coating 1 may be any of one or more graphical representations, including text and/or any other type of visual representation. FIG. 6 is a cross-section of the reinforced edible image-substrate shown in FIG. 5 illustrating the edible image-substrate coating 1 disposed on the top surface of an edible paper base layer 2, and with one or more images 4 printed or drawn on the edible image-substrate coating 1.

In certain embodiments, the reinforced edible image-substrate is distributed to end users in a finalized and decorated form. For example, popular images such as graphical representations of race cars, happy birthday text, generic star shapes, or other images that it is economically feasible to mass produce and market may be disposed onto the reinforced edible image-substrate prior to the product being distributed. Moreover, sophisticated processes such as screen printing, ink jet printing, and/or air brushing may be utilized. Additionally, custom images (e.g. an image provided by the end user to the product distributor) may be disposed onto the reinforced edible image-substrate prior to the product being distributed. However, any other suitable process of depositing an image onto a foodstuff known in the art may be used.

In different embodiments, the reinforced edible image-substrate is distributed to end users in a blank or unprinted form. There is a market for highly customizable edible image-substrates. Accordingly, in a preferred embodiment the reinforced edible image-substrate is significantly thin, flexible, and durable such that it may be used in conjunction with an ink jet printer in order to deposit any image onto the edible image-substrate coating 1 such as through the method disclosed in U.S. Pat. No. 6,652,897, to Stewart, dated Nov. 15, 2003, which is fully incorporated by reference herein.

In certain embodiments, the reinforced edible image-substrate is distributed and/or used with one or more images 4 on a single side. FIGS. 9-10 illustrate embodiments of the reinforced edible image-substrate placed on top of frosted cupcakes. In these embodiments, it is preferable that only the top side of the reinforced edible image-substrate has images thereon because the bottom side is not conspicuous. Therefore, many users would prefer to not expend the time and resources required to print on both sides. However, even when one or more sides are not conspicuous, images may be used on both sides. Moreover, even in embodiments in which the edible image-substrate coating 1 is disposed on only a single surface of the edible paper base layer 2, it is still possible to print an image on the non-covered surface of the edible paper base layer; although, image quality and/or resolution may be undesirable.

FIG. 7 is a plan view of a full or partially full sheet of a reinforced edible image-substrate comprising an edible image-substrate coating 1 which has had one or more images 4 printed or drawn on it. FIG. 8 is a cross-section of the reinforced edible image-substrate shown in FIG. 7 illustrating the edible image-substrate coating 1, with one or more images 4 printed or drawn on it, disposed on both the top surface and the bottom surface of an edible paper base layer 2.

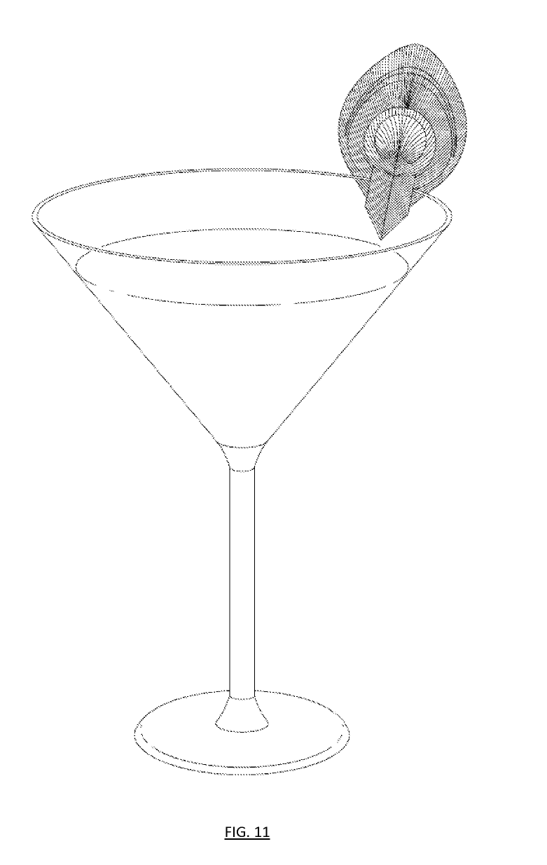

In certain embodiments, the reinforced edible image-substrate is distributed and/or used with one or more image 4 on two sides. FIG. 11 illustrates an embodiment of the reinforced edible image-substrate attached to a beverage glass for use as a decoration. In these embodiments, it is preferable that two sides of the reinforced edible image-substrate have images 4 thereon because two sides are highly conspicuous; therefore, many users would prefer to have images printed on both sides. However, even when more than one side is conspicuous images may be printed on only one side. In these embodiments, it is preferable for the edible image-substrate coating 1 to be disposed on both the top surface and the bottom surface of an edible paper base layer 2.

It is an object of the reinforced edible image-substrate disclosed herein to be both capable of accepting high-resolution images on the edible image-substrate coating 1 and also to be sufficiently stiff to retain multi-dimensional shapes without collapsing. While not readily apparent from the provided black and white figures, the quality of the high-resolution edible images is intended to be such that even photographs can be printed on the reinforced edible image-substrate with remarkable resemblance to the original source. In each of FIGS. 9-11 the stiffness of the product should be readily apparent. In FIGS. 9 and 10, the reinforced edible image-substrate has been cut into the shape of a butterfly and a kite respectively, and both have been placed on top of a frosted cupcake. Due to the reinforcement, the wings of the butterfly shape in FIG. 9 and the body and tail of the kite shape in FIG. 10 are sufficiently stiff to remain cantilevered beyond the vertical support provided by the foodstuff. In FIG. 11 the reinforced edible image-substrate has been cut into the shape of a feather and has been attached to a beverage glass with two slits. The reinforced edible image-substrate is sufficiently stiff that it retains the desired upright shape even when handled over the course of an individual consuming the contents of the glass. While it has been attempted to use standard frosting sheets to create multi-dimensional shapes, e.g., a bow for topping a cake, the frosting sheet is highly yielding and quickly collapses under even the slightest stress. Therefore, the reinforced edible image-substrate disclosed herein solves the long felt need of creating intricate and lasting multi-dimensional edible shapes.

It is yet another object of the reinforced edible image-substrate disclosed herein to be both capable of accepting high-resolution images on the edible image-substrate coating 1 and also to be sufficiently flexible to be capable of being bent, folded, and/or creased while maintaining sufficient integrity to retain desired shapes. In certain embodiments, the images 4 include indicators of where and/or in what or order to fold the product to assist the end user in creating predetermined multi-dimensional shapes, e.g., origami shapes or decorative bows. In may be desirable or necessary to create a bond between two or more portions of the reinforced edible image-substrate in order for it to maintain a desired shape. Many products and/or methods may be used to accomplish this. For example, an edible adhesive may be used. Moreover, it has also been discovered that by wetting one or more portions of the reinforced edible image-substrate and subsequently applying pressure between a wetted and another portion will quickly produce a useful bond. Therefore, the reinforced edible image-substrate disclosed herein solves the long felt need of creating intricate and lasting multi-dimensional edible shapes.

While preferred and alternate embodiments have been illustrated and described, as noted above, many changes can be made without departing from the spirit and scope of the reinforced edible image-substrate. Accordingly, the scope of the reinforced edible image-substrate is not limited by the disclosure of these preferred and alternate embodiments. Instead, the scope of the reinforced edible image-substrate should be determined entirely by reference to the claims that follow.

What is claimed is:

1. A composition for decorating edibles comprising:
an edible paper base layer having at least a top surface and a bottom surface; and
an edible image-substrate coating disposed on at least one of the top surface of the edible paper base layer and the bottom surface of the edible paper base layer.

2. The composition of claim 1, wherein the edible paper base layer having a top surface and a bottom surface is selected from the group consisting of rice paper and wafer paper.

3. The composition of claim 1, wherein the edible paper base layer having a top surface and a bottom surface comprises varying thicknesses throughout the composition.

4. The composition of claim 1, wherein the edible paper base layer having a top surface and a bottom surface further comprises at least one of:
flavoring, colorant, fragrance, preservative, salt, or any combination thereof.

5. The composition of claim 1, wherein the edible image-substrate coating disposed on at least one of the top surface of the edible paper base layer and the bottom surface of the edible paper base layer comprises at least one of: icing, sugar, water, milk, flavoring, colorant, fragrance, preservative, salt, or any combination thereof.

6. A composition for decorating edibles comprising:
an edible paper base layer having at least a top surface and a bottom surface;
an edible image-substrate coating disposed on at least one of the top surface of the edible paper base layer and the bottom surface of the edible paper base layer; and
an edible adhesive substance disposed between the edible paper base layer and the edible image-substrate coating, such that the edible adhesive substance prevents delamination of the edible paper base layer from the edible image-substrate coating.

7. The composition of claim 6, wherein the edible paper base layer having a top surface and a bottom surface is selected from the group consisting of rice paper and wafer paper.

8. The composition of claim 6, wherein the edible paper base layer having a top surface and a bottom surface comprises varying thicknesses throughout the composition.

9. The composition of claim 6, wherein the edible paper base layer having a top surface and a bottom surface further comprises at least one of:
flavoring, colorant, fragrance, preservative, salt, or any combination thereof.

10. The composition of claim 6, wherein the edible image-substrate coating disposed on at least one of the top surface of the edible paper base layer and the bottom surface of the edible paper base layer comprises at least one of: icing, sugar, water, milk, flavoring, colorant, fragrance, preservative, salt, or any combination thereof.

11. The composition of claim 6, wherein the edible adhesive substance disposed between the edible paper base layer and the edible image-substrate coating comprises at least one of:
flavoring, colorant, fragrance, sugar, honey, molasses, treacle, syrup, golden syrup, corn syrup, high fructose corn syrup, glucose, agave nectar, piping gel, or any combination thereof.

12. A method of shaping the composition of claim 1, comprising the steps of:
folding the composition into a desired shape;
wetting at least of portion of the composition; and
compressing the wetted portion of the composition onto another portion of the composition until the portions are bonded.

13. A method of shaping the composition of claim 6, comprising the steps of:
folding the composition into a desired shape;
wetting at least of portion of the composition; and
compressing the wetted portion of the composition onto another portion of the composition until the portions are bonded.
